(19) United States
(12) Patent Application Publication
(10) Pub. No.: US 2008/0154687 A1
(43) Pub. Date: Jun. 26, 2008

(54) Method And Apparatus Of On-Site Display For Showing Calendar Events Of A Conference Room

(76) Inventor: Jason Zse-Cherng Lin, Saratoga, CA (US)

Correspondence Address: LIN & ASSOCIATES INTELLECTUAL PROPERTY, INC., P.O. BOX 2339, SARATOGA, CA, 95070-0339, US

(21) Appl. No.: 11/614,974

(22) Filed: Dec. 21, 2006

(51) Int. Cl. G06Q 10/00

(52) U.S. Cl. 705/9

(57) ABSTRACT

An on-site display apparatus shows calendar events of a conference room on site for conference attendees to identify and locate the correct conference room. The on-site display apparatus including a calendar event processing unit, a calendar event storage unit, a display controller and a calendar event display device is installed in an area proximate to the conference room. The calendar event information is set up in the calendar event processing unit using a local input device, or using a networking device by a remote computer on a network. The calendar event processing unit can also retrieve calendar event information stored in a remote centralized calendar event management system through the network. Event information of a single or multiple conference sessions associated with the conference room can be displayed alternatively every few seconds so as to be more informative to the conference attendees.

### FIELD OF THE INVENTION

The present invention relates to a device for showing meeting or conference events of a conference room, and more specifically to a method and apparatus of displaying calendar events associated with a conference room in an area proximate to the conference room.

### BACKGROUND OF THE INVENTION

Meetings and conferences have become part of human's daily life. In school, class meetings are arranged in class rooms for students to get together, learn and take lessons. In corporations, employees routinely have meetings in conference rooms to discuss business, review projects and make decisions. In research and academic world, symposiums and conferences are frequently organized in large hotels or convention centers for researchers to exchange ideas and to present their research findings and results. In the industries, there are almost daily shows and conferences around the world in various businesses for people to show-case their new products and technologies, and to present their ideas for attracting customers, promoting business and seeking investment.

Logistically, the most important things for organizing any meeting or conference are to prepare a conference room of an appropriate size to accommodate meeting attendees, and to inform the attendees of the location of the conference room. Many meetings and conferences involve multiple sessions held in different conference rooms. The details of meeting events or conference schedules including session subjects or abstracts, scheduled session time, and their room locations are often distributed to the meeting attendees through memos and publications via e-mails, web-sites or post office mails so that the attendees can be present in the right meeting location at the right time.

In general, conference rooms in a corporation, hotel or convention center are identified by their room names or numbers which are designated and noted in the meeting notices or conference event calendar for various meetings. In a large conference, usually many meetings of different subjects take places in multiple conference rooms at the same time in a hotel or convention center. One of the problems often encountered in a meeting or conference is that some of the attendees who don't have the meeting notice or conference schedule with them can not find the right conference room. To solve the problem, posters are usually printed and posted near the entrance of a conference room to show what meeting is on going in the conference room. However, it is very inconvenient, time consuming and error prone to update those posters in a large conference or symposium with daily multiple sessions on going in multiple conference rooms.

In the modern corporations or organizations, there is usually a centralized meeting scheduler for employees or organization members to schedule and sign up conference rooms for their meetings. As many people may have experienced, they often can not find the meeting place when they rush for their next meeting from one to one if they forget to bring their meeting notice with them. In another worse situation, two groups of people stand in front of a conference room arguing that they both have the same conference room for their meetings without knowing that some scheduling errors might have occurred or one of the meetings might have been rescheduled.

It is clear that the problems described above can be avoided if the calendar events of a conference room in a hotel, convention center or a corporate facility can be clearly shown and updated on-site in an area proximate to the conference room. There is a need for an on-site display apparatus for showing updated and correct calendar events associated with a conference room.

### SUMMARY OF THE INVENTION

The present invention has been made to overcome the above mentioned problems often encountered by meeting attendees in identifying and finding the correct conference rooms for their meetings. The primary object of the invention is to provide an on-site display apparatus for managing, storing and displaying calendar events associated with a conference room in an area proximate to the conference room. The second object is to provide a method for showing and displaying the calendar events of a conference room on site.

According to the invention, the on-site display apparatus for showing calendar events comprises a calendar event processing unit for managing and processing the scheduled events associated with a conference room, a calendar event storage unit for saving and storing the calendar events, a calendar event display device for showing and displaying the scheduled calendar events, and a display controller that controls the calendar event display device. Communication ports or input devices are used for entering or feeding the calendar events to the calendar event processing unit.

The apparatus of the invention can be used for any meeting facilities requiring conference rooms such as class rooms in schools, meeting rooms in corporate facilities, and conference rooms in hotels or convention centers. The calendar events scheduled for a conference room can be entered through a local input device or fed through a communication port or a networking device. The communication port or networking device also enables the apparatus to fetch or retrieve calendar events from a remote calendar event management system or web site through a wired or wireless network. The apparatus is physically located in an area proximate to the conference room for associating the displayed calendar events with the conference room without ambiguity.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows the block diagram of an on-site display apparatus for showing calendar events of a conference room according to the present invention.

FIG. 2 shows that the on-site display apparatus for showing calendar events of a conference room is connected to a network for retrieving the calendar events stored in a remote calendar event management system according to the present invention.

FIG. 3 shows an example of the implementation of the on-site display apparatus according to the present invention.

FIGS. 4(A) and 4(B) show examples of information of calendar events displayed on the on-site display apparatus of the present invention.

### DETAILED DESCRIPTION OF THE PREFERRED EMBODIMENTS

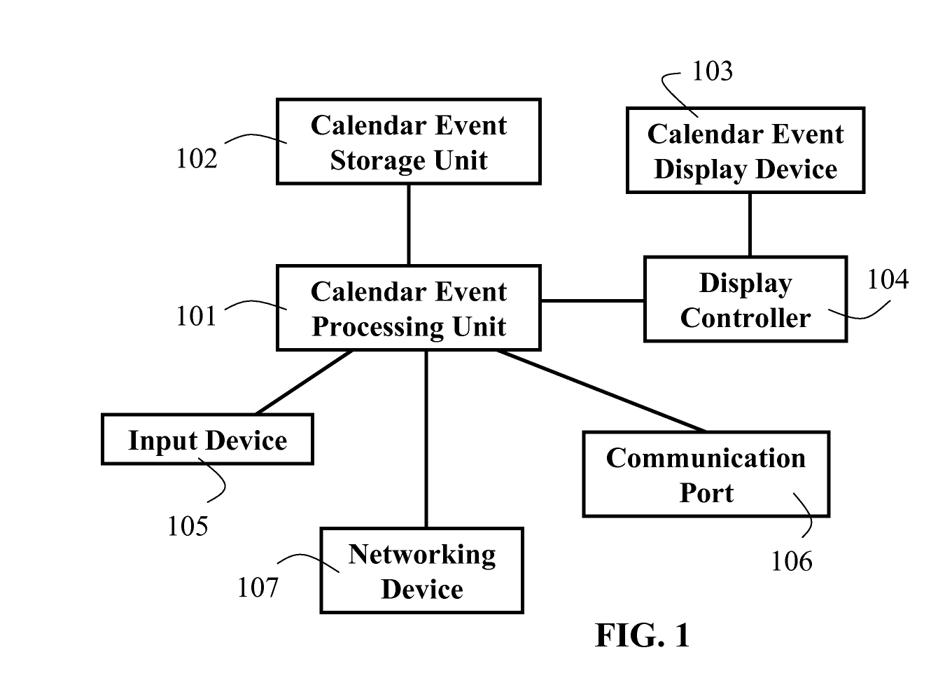

With reference to FIG. 1, a preferred embodiment of the on-site display apparatus for showing calendar events of a conference room according to the present invention comprises a calendar event processing unit 101, a calendar event storage unit 102, a calendar event display device 103, and a display controller 104. The calendar event processing unit 101 manages time, processes and schedules calendar events according to the desired meeting events entered by a user from a local input device 105 or through a communication port 106.

The calendar event on-site display apparatus of the present invention can be a standalone self-contained device or a device built with communication ports or networking devices for network communication. The local input device 105 serves as the user interface device for setting up the apparatus with proper information such as clock date and time, and entering calendar events if the apparatus is standalone and self-contained. An example of the preferred input device is an alphanumerical keypad. A communicate port 106 such as a universal serial bus port can also be used to connect a keyboard only when interface with the apparatus is required instead of having a permanent local input device to save the volume and space required for the apparatus.

The calendar event processing unit 101 is the central processing unit of the apparatus. It maintains accurate clock time for the scheduled events. Multiple meeting events for days, weeks or months may be entered and set up in the on-site display apparatus. The calendar event processing unit manages the calendar events and allows users to enter, delete or update meeting events scheduled at appropriate time along with any relevant meeting information such as a meeting subject or the title or abstract of a presentation. The calendar event processing unit 101 may be implemented by hardware components such as integrated circuits, application specific integrated circuits, or field programming gate arrays. It may also be implemented by a general purpose micro controller, digital signal processor or central processing unit with a dedicated calendar event processing firmware or software program running inside.

The calendar event storage unit 102 is a memory device for saving and storing the calendar events along with the meeting information. The memory device may be memory chips resides externally to the calendar event processing unit 101. It may also be internal memory device of a general purpose micro controller, digital signal processor or central processing unit. The calendar event display device 103 can be a graphics display device such as a liquid crystal display similar to those commonly used in a notebook or television or a large screen plasma display. The display controller 104 provides the driving circuits for controlling the calendar event display device 103 to display the calendar event information sent from the calendar event processing unit 101. The display controller 104 may also be embedded in the calendar event processing unit 101.

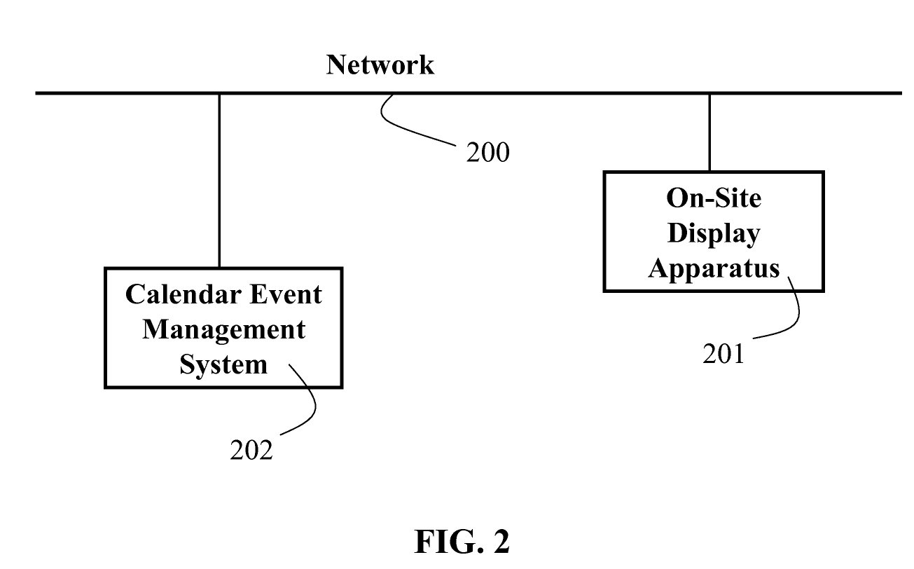

As mentioned above, the on-site display apparatus for showing calendar events of a conference room according to the present invention may also be built with communication ports or a networking device 107 for network communication. The apparatus can therefore be managed and set up remotely by means of the network communication through the networking device 107. In other words, the setup of the apparatus and the desired calendar events can be entered, configured and updated through the network without using a local input device once a network address is assigned to the on-site display apparatus. The apparatus of the present invention can be managed through its networking device with a remote computer or calendar event management system as shown in FIG. 2.

In many corporate facilities and convention centers, a centralized calendar event management system is usually set up in the corporate information system for managing, scheduling and maintaining multiple conference events of multiple conference rooms. With reference to FIG. 2, an on-site display apparatus 201 implemented according to the block diagram of FIG. 1 is equipped with a networking device for accessing a network 200 through a wired or wireless connection. A centralized calendar event management system 202 is also connected to the network with a wired or wireless connection.

As described above, the centralized calendar event management system 202 maintains calendar events of multiple conference rooms. The calendar events are usually made available on the network, for example, through a web site. The on-site display apparatus 201 retrieves the calendar events of its associated conference room from the centralized calendar event management system 202 through the network and displays the meeting information on its calendar event display device 104. In this case, the calendar event processing unit 101 is responsible for querying the centralized calendar event management system 202 and retrieving the timely calendar event information and the calendar event storage unit 102 serves as the temporary storage of the information to be displayed.

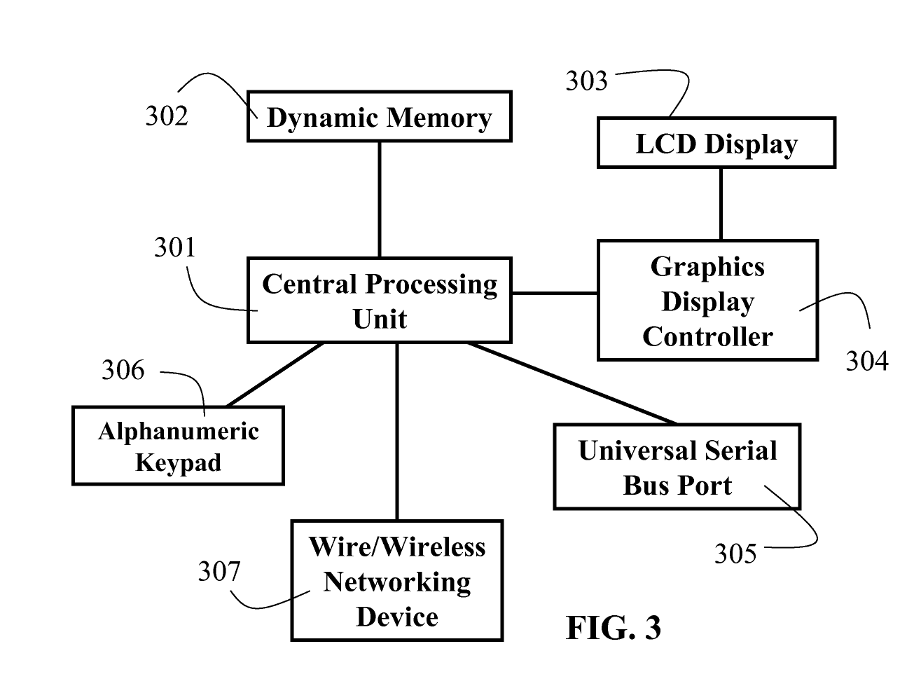

FIG. 3 illustrates an example of the on-site display apparatus for showing calendar events of a conference room according to the present invention. A central processing unit 301 is used as a calendar event processing unit for executing a calendar event management program. A dynamic memory device 302 stores the calendar event information of the associated conference room. A liquid crystal display 303 displays the calendar events and a graphic display controller 304 controls the liquid crystal display 303. A network accessing device 307 provides wired or wireless communication with a network. An optional universal serial bus port 305 or alphanumeric keypad 306 can also be provided for the apparatus.

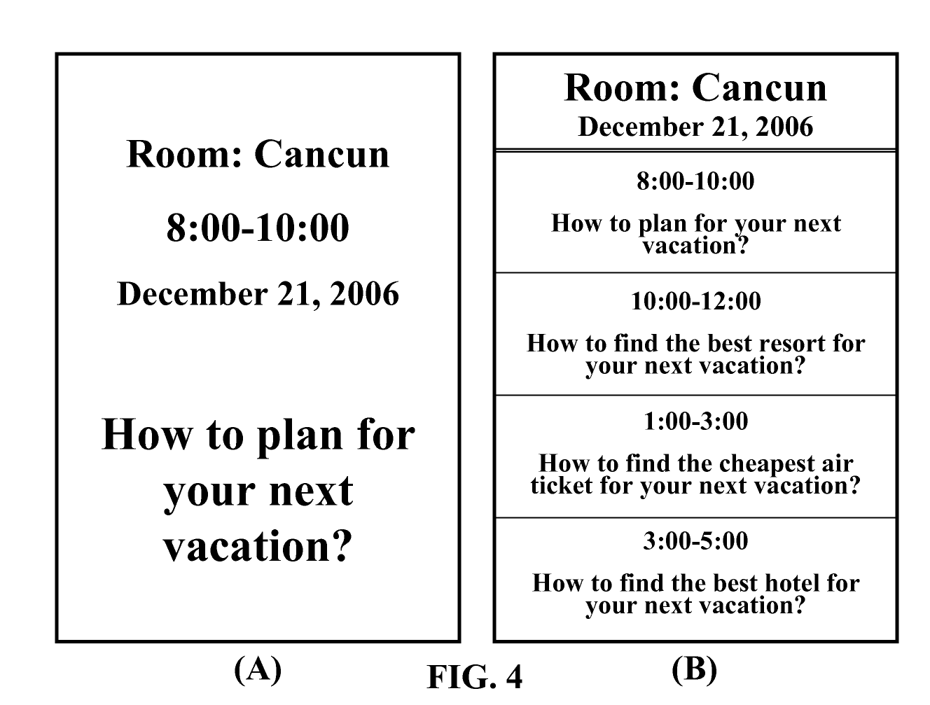

According to the present invention, the on-site display apparatus for showing calendar events of a conference room can display calendar events in various modes. For example, the event information of a single conference session currently on going in the associated conference room can be displayed as shown in the screen shot of FIG. 4(A). The event information displayed may include the name of the conference room, the current time and the subject of the current conference session. The event information of multiple conference sessions in the same day can also be displayed as shown in the screen shot of FIG. 4(B). To be more informative, the screen shots of a single and multiple conference sessions of the associated conference room can be displayed alternatively once every few seconds. For example, each is displayed every five or ten seconds to show the event of the current time and the events for the whole day.

For deploying the on-site display apparatus of showing calendar events of a conference room according to the invention, the on-site display apparatus is usually installed on a wall near the entrance of a conference room. The on-site display apparatus can be powered with batteries or plugged into a power supply. Dependent on the size of the conference room and the desired visibility, the size of the display device on the apparatus may be designed accordingly. Dependent on the availability of a network, the on-site display can be equipped with a network accessing device or be implemented as a stand-alone self-contained device. When the conference room is not in use, the on-site display apparatus can also be used for showing various advertising or displaying other desired information.

Although only the preferred embodiments of this invention were shown and described in the above description, various modification, substitution or combination that comes within the spirit of this invention may also be made by a person skilled in the field according to the principle described. Therefore, all such substitutions and modifications are intended to be embraced within the scope of the invention as defined in the appended claims.

What is claimed is:

1. An onsite display apparatus for showing calendar events of a conference room, comprising:
a calendar event processing unit for managing and processing said calendar events associated with said conference room;
a calendar event storage unit for storing information of said calendar events;
a display controller connected to said calendar event processing unit for receiving information of said calendar events to be displayed;
a calendar event display device controlled by said display controller for displaying the information of said calendar events to be displayed.

2. The onsite display apparatus for showing calendar events of a conference room as claimed in claim 1, wherein said calendar event processing unit is implemented by a general purpose computing processor with a calendar event management program running in said general purpose computing processor.

3. The onsite display apparatus for showing calendar events of a conference room as claimed in claim 1, further comprising a local input device.

4. The onsite display apparatus for showing calendar events of a conference room as claimed in claim 3, wherein said local input device is an alphanumeric keypad.

5. The onsite display apparatus for showing calendar events of a conference room as claimed in claim 1, further comprising at least a communication port.

6. The onsite display apparatus for showing calendar events of a conference room as claimed in claim 5, wherein said at least a communication port includes a universal serial bus port.

7. The onsite display apparatus for showing calendar events of a conference room as claimed in claim 1, further comprising a networking device for said onsite display apparatus to access a network, and said calendar events associated with said conference room being entered to said calendar event processing unit from a remote computer through said network.

8. The onsite display apparatus for showing calendar events of a conference room as claimed in claim 7, wherein said networking device is a wireless network accessing device.

9. The onsite display apparatus for showing calendar events of a conference room as claimed in claim 1, further comprising a networking device for said onsite display apparatus to access a network, and said calendar events associated with said conference room being retrieved from a remote calendar event management system on said network by said calendar event processing unit through said network.

10. The onsite display apparatus for showing calendar events of a conference room as claimed in claim 9, wherein said networking device is a wireless network accessing device.

11. A method for showing calendar events of a conference room on site, comprising the steps of:
installing an on-site display apparatus in an area proximate to said conference room, said on-site display apparatus having a calendar event processing unit, a calendar event storage unit, a display controller and a calendar event display device;
setting up said calendar events associated with said conference room in said calendar event processing units and storing information of said calendar events in said calendar event storage unit;
sending information of said calendar events to be displayed from said calendar event storage unit to said display controller; and
displaying the information of said calendar events to be displayed on said calendar event display device.

12. The method for showing calendar events of a conference room on site as claimed in claim 11, wherein the information of said calendar events to be displayed includes event information of a current conference session and event information of multiple conference sessions, and the step of displaying the information is accomplished by displaying the event information of a current conference session and multiple conference sessions alternatively once every several seconds.

13. The method for showing calendar events of a conference room on site as claimed in claim 11, wherein the step of setting up said calendar events associated with said conference room in said calendar event processing unit is accomplished by using a local input device connected to said calendar event processing unit.

14. The method for showing calendar events of a conference room on site as claimed in claim 13, wherein said local input device is an alphanumeric keypad.

15. The method for showing calendar events of a conference room on site as claimed in claim 11, wherein the step of setting up said calendar events associated with said conference room in said calendar event processing unit is accomplished through a communication port.

16. The method for showing calendar events of a conference room on site as claimed in claim 15, wherein said communication port is a universal serial bus port.

17. The method for showing calendar events of a conference room on site as claimed in claim 11, wherein said on-site display apparatus further comprises a networking device for said onsite display apparatus to access a network, and the step of setting up said calendar events associated with said conference room in said calendar event processing unit is accomplished by using a remote computer through said network.

18. The method for showing calendar events of a conference room on site as claimed in claim 17, wherein said networking device is a wireless network accessing device.

19. The method for showing calendar events of a conference room on site as claimed in claim 11, wherein said on-site display apparatus further comprises a networking device for said onsite display apparatus to access a network, and the step of setting up said calendar events associated with said conference room in said calendar event processing unit is accomplished by retrieving said calendar events from a remote calendar event management system on said network using said calendar event processing unit through said network.

20. The method for showing calendar events of a conference room on site as claimed in claim 19, wherein said networking device is a wireless network accessing device.
